(19) United States
(12) Patent Application Publication
(10) Pub. No.: US 2024/0282035 A1
(43) Pub. Date: Aug. 22, 2024

(54) METHODS FOR CORRECTING AND/OR MITIGATING TISSUE PENETRATION IN ANATOMICAL SIMULATION MODELS FOR COMPUTER ANIMATION

(71) Applicant: David Sebastian MINOR, Vancouver (CA)

(72) Inventor: David Sebastian MINOR, Vancouver (CA)

(73) Assignee: Digital Domain Virtual Human (US), Inc., Los Angeles, CA (US)

(21) Appl. No.: 18/653,923

(22) Filed: May 2, 2024

Related U.S. Application Data
(63) Continuation of application No. PCT/CA2022/050650, filed on Apr. 28, 2022.
(60) Provisional application No. 63/283,415, filed on Nov. 26, 2021.

(51) Int. Cl. G06T 13/40; G06T 17/20; G06T 19/20

(52) U.S. Cl. CPC G06T 13/40; G06T 17/20; G06T 19/20; G06T 2210/41; G06T 2219/2004

(57) ABSTRACT

Methods are provided for generating high fidelity musculoskeletal models for computer animation. The methods may comprise locating at least one interpenetration, overlap and/or intersection of a first tissue with a second tissue in the model. Representations of at least one of the first and second tissues may be eroded to remove the interpenetration. A separation gap may be introduced between adjacent tissues of the model. The first and second tissues may be eroded symmetrically.

### REFERENCE TO RELATED APPLICATIONS

This application is a continuation of Patent Cooperation Treaty (PCT) application No. PCT/CA2022/050650 having an international filing date of 28 Apr. 2022 which in turn claims priority to, and for the purposes of the United States, the benefit under 35 USC § 119 in connection with, U.S. application No. 63/283,415 filed 26 Nov. 2021. All of the applications referred to in this paragraph are hereby incorporated herein by reference.

### FIELD

The present disclosure relates to methods for computer animation. Some embodiments provide methods useful for simulating tissues and, in particular, for correcting and/or mitigating tissue penetration in anatomical simulation models.

### BACKGROUND

Relatively recently, two-dimensional and three-dimensional computer-based graphic (CGI) simulations have been developed which use computer-based models to simulate the movement of objects as between digital image frames and to thereby provide data which can be used to animate moving objects within a sequence of digital image frames.

CGI simulation may often include simulation and/or animation of musculoskeletal systems comprising a rigid-body (e.g. skeletal) system and a system of deformable, but volume preserving solids (e.g. soft tissue, such as muscle and fat), which interacts with the rigid-body system. Such animation may simulate movement of the musculoskeletal system. Such simulations may be used to generate corresponding animations of the musculoskeletal systems and/or similar systems, which animations comprise ordered sequences of complete or partial digital image frames often referred to as “Computer-Generated Imagery” (CGI) video data, CGI animation data or CGI moving picture data. There is a general desire that such animations, when rendered by suitable computer-based graphics engines, provide musculoskeletal animation that appears realistic to viewers.

To produce high quality simulations of CGI characters, high anatomical fidelity of the simulated musculoskeletal systems is typically desired. Having high anatomical fidelity within a CGI simulation often includes building detailed models of the musculature and the skeleton of the musculoskeletal system being modeled. For such models to be compatible with physics based simulation, there is a desire that tissue components within the models do not overlap, interpenetrate and/or intersect in space. Together, overlapping, interpenetration and/or intersection of tissue components in space may be referred to herein as interpenetration of tissues or tissue components or, even more simply, tissue penetration. Manually correcting the tissue models to mitigate tissue penetration may be significantly labor intensive.

There is a need for improved methods for modeling tissue. There is a desire for methods to provide models which correct and/or mitigate tissue penetration.

### SUMMARY

Further aspects and example embodiments are illustrated in the accompanying drawings and/or described in the following description.

This invention has many aspects. These include (non-limiting):
methods for manipulating tissue of a model;
methods for removing overlapping, intersecting and/or interpenetrating tissues within a model;
methods for separating adjacent tissues within a model;
etc.

One aspect of the invention provides a method for mitigating tissue penetration in a musculoskeletal model used for computer animation. The method comprises: obtaining a computer-based input representation of the musculoskeletal system, the input representation comprising an input surface mesh for each of a plurality of tissue components; for each of the tissue components, generating a signed distance field, the signed distance field comprising: a plurality of voxels arranged in a three-dimensional grid; and, for each voxel, a signed distance function value indicative of a distance of the voxel from a surface of the tissue component and whether the voxel is inside of the tissue component or outside of the tissue component; for each of one or more particular tissue components from among the plurality of tissue components, modifying a signed distance field of the particular tissue component to thereby generate a corresponding modified signed distance field for the particular tissue component; generating a computer-based output representation of the musculoskeletal system, wherein generating the output representation comprises, for each of the one or more particular tissue components, generating a corresponding output surface mesh for the particular tissue component based on the corresponding modified signed distance field for the particular tissue component.

For each of the one or more particular tissue components, the corresponding output surface mesh for the particular tissue component may be free from penetration by other ones of the plurality of tissue components.

Generating the signed distance field may comprise, for each tissue component and for each voxel: adopting one of: a first sign convention wherein a negative signed distance function value indicates that the voxel is located inside of the tissue component and a positive signed distance function value indicates that the voxel is outside of the tissue component; and a second sign convention wherein a positive signed distance function value indicates that the voxel is located inside of the tissue component and a negative signed distance function value indicates that the voxel is outside of the tissue component. It is assumed, throughout this description that the first sign convention is used. Those skilled in the art will appreciate the analogous logic (to that applied in the first sign convention) may be used for embodiments which adopt the second sign convention.

Generating the signed distance field may comprise adopting the first sign convention and modifying the signed distance field of the particular tissue component may comprise: identifying one or more neighboring tissue components and one or more corresponding neighboring signed distance fields from among the other ones of the plurality of tissue components; for each voxel of a subset of voxels of the signed distance field of the particular tissue component: for each of the neighboring tissue components: if an original signed distance function value for the voxel of the subset is greater than a neighbor value sampled from original signed distance values of one or more corresponding voxels of the neighboring tissue component, then assigning, to the voxel of the subset, a modified signed distance function value that is positive; otherwise assigning, to the voxel of the subset, a modified signed distance function value that is equal to the original signed distance function value for the voxel of the subset; or generating the signed distance field may comprise adopting the second sign convention and modifying the signed distance field of the particular tissue component may comprise, for each voxel of a subset of voxels of the signed distance field of the particular tissue component, modifying the signed distance function value of the voxel of the subset in a manner according to analogous logic to that recited above for the first sign convention.

Generating the signed distance field may comprise adopting the first sign convention and modifying the signed distance field of the particular tissue component may comprise: identifying one or more neighboring tissue components and one or more corresponding neighboring signed distance fields from among the other ones of the plurality of tissue components; for each voxel of a subset of voxels of the signed distance field of the particular tissue component: for each of the neighboring tissue components: if the neighboring tissue component has a tissue component type of bone or the tissue component is otherwise indicated to be non-modifiable and a neighbor value sampled from the original signed distance values of one or more corresponding voxels of the neighboring tissue component is negative, then assigning, to the voxel of the subset, a modified signed distance function value that is positive; if the neighboring tissue component has any other tissue component type or is otherwise indicated to be modifiable and an original signed distance function value for the voxel of the subset is greater than a neighbor value sampled from original signed distance values of one or more corresponding voxels of the neighboring tissue component, then assigning, to the voxel of the subset, a modified signed distance function value that is positive; otherwise assigning, to the voxel of the subset, a modified signed distance function value that is equal to the original signed distance function value for the voxel of the subset; or generating the signed distance field may comprise adopting the second sign convention and modifying the signed distance field of the particular tissue component may comprise, for each voxel of a subset of voxels of the signed distance field of the particular tissue component, modifying the signed distance function value of the voxel of the subset in a manner according to analogous logic to that recited above for the first sign convention.

Identifying one or more neighboring tissue components and one or more corresponding neighboring signed distance fields from among the other ones of the plurality of tissue components may comprise identifying all of the other ones of the plurality of tissue components to be neighboring tissue components.

Identifying one or more neighboring tissue components and one or more corresponding neighboring signed distance fields from among the other ones of the plurality of tissue components may comprise identifying, as the one or more neighboring tissue components, tissue components from among the plurality of tissue components that overlap in space with the particular tissue component.

Identifying tissue components from among the plurality of tissue components that overlap in space with the particular tissue component may comprise: generating a bounding box for each of the plurality of tissue components wherein the bounding box comprises, for each of the plurality of tissue components, a spatial coordinate range of the tissue component in three dimensions; and comparing the bounding box of the particular tissue component to the bounding box of each of the other ones of the plurality of tissue components to thereby determine neighboring tissue components as those whose spatial coordinate ranges overlap with that of the particular tissue component on the three dimensions.

The method may comprise, for each voxel of the subset of voxels of the signed distance field of the particular tissue component and for each of the neighboring tissue components: determining the neighbor value sampled from original signed distance values of one or more corresponding voxels of the neighboring tissue component based on determining the one or more corresponding voxels of the neighboring tissue component to overlap in space with the voxel of the subset.

For each voxel of the subset of voxels of the signed distance field of the particular tissue component and for each of the neighboring tissue components, determining the neighbor value sampled from original signed distance values of one or more corresponding voxels of the neighboring tissue component may comprise interpolating the original signed distance function values of the one or more corresponding voxels of the neighboring tissue component.

Interpolating the original signed distance function values of the one or more corresponding voxels of the neighboring tissue component may comprise at least one of: bilinear interpolation and bicubic interpolation.

Generating the signed distance field may comprise adopting the first sign convention and modifying the signed distance field of the particular tissue component may comprise: identifying one or more neighboring tissue components and one or more corresponding neighboring signed distance fields from among the other ones of the plurality of tissue components; for each voxel of a subset of voxels of the signed distance field of the particular tissue component, assigning, to the voxel of the subset, a modified signed distance function value that is a maximum of: an original signed distance function value for the voxel of the subset; and for each of the neighboring tissue components: a difference between an original signed distance function value for the voxel of the subset and a neighbor value sampled from original signed distance values of one or more corresponding voxels of the neighboring tissue component plus an offset Δ; or generating the signed distance field may comprise adopting the second sign convention and modifying the signed distance field of the particular tissue component may comprise, for each voxel of a subset of voxels of the signed distance field of the particular tissue component, modifying the signed distance function value of the voxel of the subset in a manner according to analogous logic to that recited above for the first sign convention.

Generating the signed distance field may comprise adopting the first sign convention and modifying the signed distance field of the particular tissue component may comprise: identifying one or more neighboring tissue components and one or more corresponding neighboring signed distance fields from among the other ones of the plurality of tissue components; for each voxel of a subset of voxels of the signed distance field of the particular tissue component, assigning, to the voxel of the subset, a modified signed distance function value that is a maximum of: an original signed distance function value for the voxel of the subset; for each of the neighboring tissue components having a tissue component type of bone or where the neighboring tissue component is otherwise indicated to be non-modifiable, a negative of a neighbor value sampled from original signed distance values of one or more corresponding voxels of the neighboring tissue component plus an offset Δ; and for each of the neighboring tissue components having any other tissue component type or where the neighboring tissue component is otherwise indicated to be modifiable, a difference between an original signed distance function value for the voxel of the subset and a neighbor value sampled from original signed distance values of one or more corresponding voxels of the neighboring tissue component plus an offset Δ; or generating the signed distance field may comprise adopting the second sign convention and modifying the signed distance field of the particular tissue component may comprise, for each voxel of a subset of voxels of the signed distance field of the particular tissue component, modifying the signed distance function value of the voxel of the subset in a manner according to analogous logic to that recited above for the first sign convention.

Identifying one or more neighboring tissue components and one or more corresponding neighboring signed distance fields from among the other ones of the plurality of tissue components may comprise identifying all of the other ones of the plurality of tissue components to be neighboring tissue components.

Identifying one or more neighboring tissue components and one or more corresponding neighboring signed distance fields from among the other ones of the plurality of tissue components may comprise identifying, as the one or more neighboring tissue components, tissue components from among the plurality of tissue components that overlap in space with the particular tissue component.

Identifying tissue components from among the plurality of tissue components that overlap in space with the particular tissue component may comprise: generating a bounding box for each of the plurality of tissue components wherein the bounding box comprises, for each of the plurality of tissue components, a spatial coordinate range of the tissue component in three dimensions; and comparing the bounding box of the particular tissue component to the bounding box of each of the other ones of the plurality of tissue components to thereby determine neighboring tissue components as those whose spatial coordinate ranges overlap with that of the particular tissue component on the three dimensions.

The method may comprise, for each voxel of the subset of voxels of the signed distance field of the particular tissue component and for each of the neighboring tissue components: determining the neighbor value sampled from original signed distance values of one or more corresponding voxels of the neighboring tissue component based on determining the one or more corresponding voxels of the neighboring tissue component to overlap in space with the voxel of the subset.

For each voxel of the subset of voxels of the signed distance field of the particular tissue component and for each of the neighboring tissue components, determining the neighbor value sampled from original signed distance values of one or more corresponding voxels of the neighboring tissue component may comprise interpolating the original signed distance function values of the one or more corresponding voxels of the neighboring tissue component.

Interpolating the original signed distance function values of the one or more corresponding voxels of the neighboring tissue component comprises at least one of: bilinear interpolation and bicubic interpolation.

The offset value Δ may be Δ=0. The offset value Δ may be Δ>0. The offset value Δ may be Δ≥0 and the offset value may be different as between at least some of the neighboring tissue components.

Generating the corresponding output surface mesh for the particular tissue component based on the corresponding modified signed distance field for the particular tissue component may comprise: determining a zero isosurface of the corresponding modified signed distance field for the particular tissue component; for each vertex of the input surface mesh for the particular tissue component, determining a corresponding point on the zero isosurface to be a corresponding output vertex of the corresponding output surface mesh; and determining a final configuration of the corresponding output surface mesh by allowing the output vertices of the corresponding output surface mesh to move while constraining the output vertices of the corresponding output surface mesh to the zero isosurface.

For each vertex of the input surface mesh for the particular tissue component, determining the corresponding point on the zero isosurface to be the corresponding output vertex of the corresponding output surface mesh may comprise determining a closest point on the zero isosurface to the vertex of the input surface mesh for the particular tissue component.

Allowing the output vertices of the corresponding output surface mesh to move while constraining the output vertices of the corresponding output surface mesh to the zero isosurface may comprise performing an iterative constrained optimization operation that minimizes an energy function which assigns cost to deformation of the corresponding output surface mesh for the particular tissue component relative to the input surface mesh for the particular tissue component while constraining the output vertices of the corresponding output surface mesh to the zero isosurface.

A number of iterations of the iterative constrained optimization operation may be a user-configurable parameter of the method.

For each of the tissue components, a size of the voxels in the signed distance field may be a user-configurable parameter.

Another aspect of the invention provides a system for mitigating tissue penetration in as musculoskeletal model used for computer animation, the system comprising a processor configured (e.g. by suitable programming) to perform any of the methods described above or otherwise disclosed herein.

Another aspect of the invention provides a computer program product comprising a non-transient computer-readable storage medium having data stored thereon representing software executable by a process, the software comprising instructions to perform any of the methods described above or otherwise disclosed herein.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1A is a perspective view of an example tissue model comprising a plurality of tissue components.

FIG. 1B is a perspective view of a modified version of the FIG. 1A model which has been generated using a method according to an embodiment of the invention.

FIG. 2 is a block diagram illustrating an example method for correcting and/or mitigating tissue penetration according to an embodiment of the invention.

FIG. 2A schematically illustrates a method that may be used for the FIG. 2 process of identifying and removing intersections/interpenetrations/overlap from tissue components according to a particular embodiment.

FIGS. 3A-3I schematically illustrate representations of tissue components in example animation models generated using methods according to embodiments of the invention.

FIG. 4 depicts an exemplary system for performing one or more methods described herein (e.g. the methods of FIGS. 2, 2A) according to a particular embodiment.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One aspect of the technology described herein discloses methods for constructing and/or modifying digital models of musculature and/or skeleton tissue and/or other types of anatomical tissue. The models may be used to simulate high quality tissue deformations of characters (e.g. humans or other animals, fictional creatures (e.g. extra-terrestrial life-forms such as aliens, avatars, mythical creatures, etc.), etc.) in animation or other computer generated imagery (CGI) work products. In some embodiments, the methods produce models with high anatomical fidelity (e.g. models which have enough anatomical detail that desired events or actions, such as muscle contractions, muscle movement under skin, etc. can be modeled as desired) while mitigating tissue penetration. Where tissue models are modified in accordance with methods according to particular embodiments, adjacent tissue components in the model are modified to remove any instances of tissue penetration and adjacent tissue components may be separated from each other by a configurable distance (e.g. a gap) to improve stability of a simulation performed using the modified tissue model. When stability of a simulation is improved, the likelihood of undesirable effects (e.g. jittering, tissue jumps at the start or during a simulation, tissue components (e.g. muscles) pushing each other apart, etc.) may be reduced and instances of tissue penetration may be mitigated.

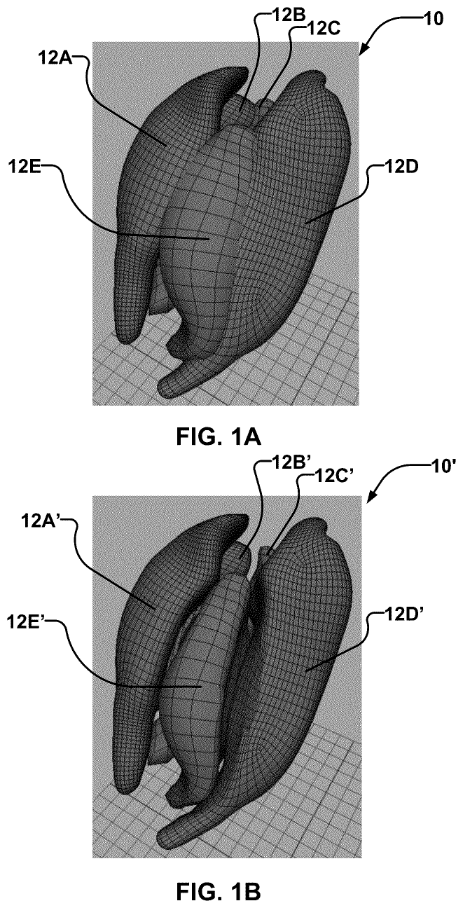

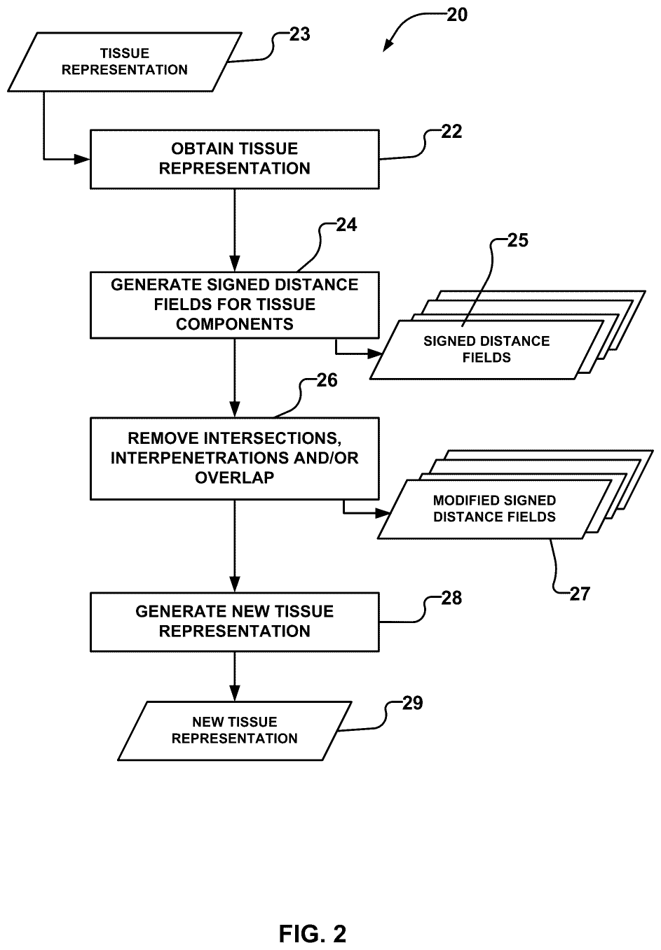

FIG. 1A shows a tissue model 10 having tissue components 12A, 12B, 12C, 12D and 12E (collectively, tissue components 12). As shown in FIG. 1A, adjacent tissue components 12 overlap, interpenetrate and/or intersect one another—i.e. there is tissue penetration between tissue components 12. Such tissue penetration of the modeled tissue components 12 may adversely impact the quality of any tissue simulations performed using model 10. For example, tissue model 10:
may be unstable during simulations;
may simulate incorrect tissue behavior when regions of the tissue are stimulated by actions, such as being deformed, stretched, relaxed, etc. (e.g. upon tissue component 12A being deformed, tissue model 10 may deform both tissue components 12A and 12B when only muscle tissue component 12A should be deformed);
may exhibit tissue penetration during simulations;
etc.

FIG. 1B shows a tissue model 10′ generated using a method (e.g. method 20) as described herein. Tissue components 12A′, 12B′, 12C′, 12D′ and 12E′ (collectively tissue components 12′) of the FIG. 1B model 10′ correspond to tissue components 12A, 12B, 12C, 12D and 12E respectively of the FIG. 1A model 10. However, in model 10′, tissue components 12′ do not overlap, interpenetrate and/or intersect one another (i.e. there is no tissue penetration as between tissue components 12′). Model 10′ may advantageously produce higher fidelity simulations of the tissue components 12′, may producer faster simulations (due to, for example, a reduced amount of collisions that may occur at any given time), may be compatible with commercially available simulation software products (e.g. Houdini™ developed by Side Effects Software Inc., a Ziva™ simulator developed by Ziva Dynamics, etc.) and/or the like.

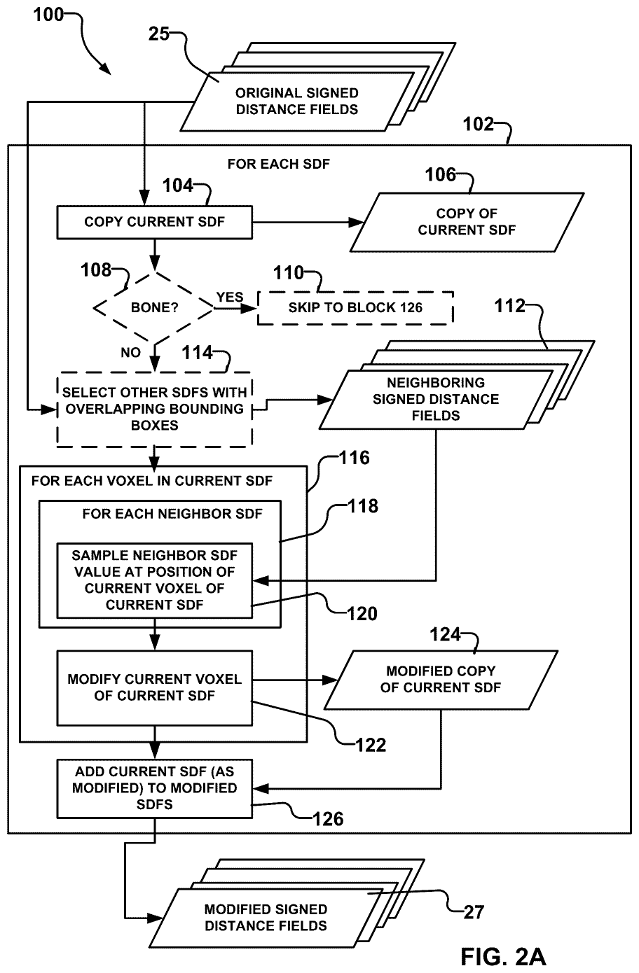

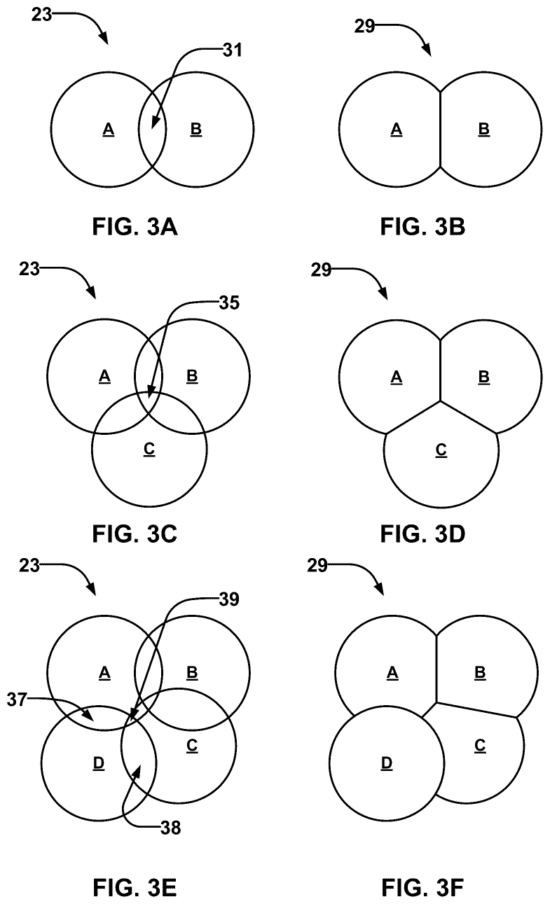

FIG. 2 is a flow chart showing an example method 20 for generating and/or modifying a tissue model 10′ according to a particular embodiment.

Method 20 begins in block 22, where a representation 23 of tissue to be modeled is obtained. Tissue to be modeled may include a variety of tissue components, such as muscle tissue components, bone tissue components, etc. of a particular anatomical region or regions. For example, if a human arm is to be modeled, representation 23 may comprise tissue components corresponding to representations of the radius bone tissue, the ulna bone tissue, the elbow bone tissue and/or the humerus bone tissue as well as representations of the surrounding muscle tissue. In some embodiments, representation 23 comprises representations of one or more connective tissue components, such as tendons, ligaments or other such structures. Additionally, or alternatively, representation 23 may comprise representations of one or more fat tissue components. In some embodiments, a user may select what tissue representation 23 comprises (e.g. only muscle tissue component(s), only bone tissue component(s), only connective tissue component(s), combinations of two or more different tissue types, etc.).

Representation 23 comprises typically comprises one or more three-dimensional (3D) polygonal surface meshes which define the surface and volume of the tissue components to be modeled. The meshes of input representation 23 may comprise triangle meshes, quad meshes, general polygonal meshes and/or the like. Typically, the meshes of input representation 23 are generally closed. In currently preferred embodiments, representation 23 comprises one or more triangle meshes of the tissue components to be modeled. In some embodiments, tissue to be modelled is originally represented by one type of polygonal mesh, but is converted into a second, different type of polygonal mesh for further processing, as described herein (e.g. from a quad mesh to a triangle mesh). Different tissue components may be represented by the same type of polygonal mesh or with different types of polygonal mesh.

Method 20 then proceeds to block 24, which involves generating signed distance fields 25 (based on signed distance functions) for the different tissue components within representation 23. The signed distance fields 25 generated in block 24 may be generated using any presently known or future discovered method. For example, each signed distance field 25 may be generated using a fast marching method, a fast sweeping method, a level-set method and/or the like. Such methods receive (as input) a surface mesh of the tissue component and output a 3D grid (e.g. an ordered set of voxels) with signed distance function values for each voxel of the 3D grid. One signed distance field 25 may be generated for each tissue component of input representation 23. For a particular tissue component of input representation 23, if a voxel is within (inside) the volume of the tissue component, then the signed distance function value assigned to that voxel may be negative; if a voxel is on the boundary/surface of the tissue component, then the signed distance function value assigned to that voxel may be zero; and if a voxel is outside of the volume of that tissue component, then the signed distance function value assigned to that voxel may be positive. In some embodiments, the opposite sign convention could be used. A signed distance field 25 for different tissue components within representation 23 may be generated using the same method or different methods. In some embodiments, method 20 is optimized to select a signed distance field generating method (for use in block 24) based on one or more factors, such as speed, efficiency, computational resource requirements, ease of parallelizing, etc. In some embodiments, a fast sweeping method may make it easy to parallelize the generation of the signed distance fields 25 in block 24.

The block 24 signed distance fields 25 generated for the representation 23 tissue components may be sampled on a three-dimensional grid of voxels (i.e. a signed distance function value may be determined and assigned for each voxel of a 3D grid). A quality factor of model 10′ to be generated using method 20 may depend at least partially on the sampling resolution (e.g. voxel size) of the three-dimensional grid. In some embodiments, this parameter (e.g. voxel size, signed distance field sampling resolution and/or the like) may be a user-configurable parameter of method 20. Having a coarser resolution (e.g. larger voxel size) may reduce computational resources that are involved in the performance of method 20, increase speed, etc., but may result in a lower quality model 10′. This parameter may be set at the same value for all tissue components or may be configurable for each individual tissue component and its corresponding signed distance field 25.

In some embodiments, the signed distance field sampling resolution (e.g. voxel size) may be varied in real-time. In some embodiments, the signed distance function sampling resolution (e.g. voxel size) is varied by a user until a desirable quality factor of model 10′ is obtained. In some embodiments, the user commences with a coarse resolution (relatively large voxel size) and incrementally increases the sampling resolution (decreases the voxel size) until a desired quality of model 10′ is obtained. In some embodiments, a user commences with a resolution that is based on a size of a typical polygon in the meshes of input representation. For example, if a typical or average maximal edge length of a suitable sample of polygons in a mesh of input representation 23 is x, then a user may start with cuboid voxels having edge lengths of x. In some embodiments, the sampling resolution is increased (voxel edge length is increased) in increments of about 5% of the maximal edge length of the typical or average polygon in the mesh. In currently preferred embodiments, the sampling resolution (e.g. voxel edge length) is in the range of about +30% of the size (e.g. maximal edge length) of a typical or average polygon in the mesh.

Once signed distance fields 25 are generated over a 3D grid of voxels in block 24, method 20 proceeds to block 26, where intersections, interpenetrations and/or overlapping between different tissue components are identified and removed from the corresponding signed distance fields 25 to generate modified signed distance fields 27. Block 26 may involve, for each signed distance field 25 corresponding to each tissue component:
(i) identifying other signed distance fields (corresponding to other tissue components) whose bounding boxes overlap with the bounding box of the current signed distance field 25;
(ii) making a copy of the current signed distance field 25 (also referred to herein as original signed distance field 25) having original signed distance values); and
(iii) iterating over the voxels in the copied signed distance field and generating new signed distance function values for each voxel to thereby erode the current tissue component in a manner which removes the intersecting, interpenetrating and/or overlapping portions.
   In some embodiments, step (iii) may be limited to iterating over voxels of the copied current signed distance field which are identified as having other (neighboring) signed distance fields (corresponding to other (neighboring) tissue components) that overlap with such voxels. Other voxels in the copied current signed distance field (i.e. voxels without other overlapping signed distance fields) may retain their original signed distance function values. In some embodiments, the new (modified) signed distance function values assigned to voxels of the copied current signed distance field may be based on one or more of: the original signed distance function value for that voxel; and signed distance function values sampled from the overlapping signed distance fields. It should be noted that step (i) is optional. That is, in some embodiments, it is not necessary to identify other signed distance fields (corresponding to other tissue components) as overlapping with the current signed distance field. Instead, every other signed distance field may be considered when iterating over the voxels of the copied current signed distance field.

As discussed above, a separate signed distance field 25 may be generated (in block 24) for each tissue component (e.g. each muscle tissue component, each bone tissue component, etc.). The different signed distance fields 25 of different tissue components may have the same or a different coordinate system. Because of this, evaluating signed distance field values for a neighboring tissue component at the center of a voxel during voxel iteration for the current tissue component may comprise sampling from (e.g. interpolating between) signed distance function values from a plurality of voxels of the neighboring signed distance field 25. For example, where each signed distance field 25 corresponding to each tissue component has its own coordinate system, voxels of a first signed distance field 25 from a particular tissue component A might be in different 3D positions than voxels of a second signed distance field 25 from a second tissue component B. Consequently, when iterating over the voxels of the signed distance field for tissue component A (i.e. tissue component A is the current tissue component), finding the signed distance function value for tissue component B in one of the voxels for tissue component A, may involve interpolating between the signed distance function values of two or more voxels of tissue component B.

To de-penetrate the tissue components, block 26 may involve iterating through each voxel of the copied version of each signed distance field 25. A new signed distance function value assigned to a voxel from a particular tissue component identified as being intersecting/interpenetrating/overlapping with a voxel of one or more other tissue components may depend on: the original signed distance function value of that voxel for the particular tissue component and the original signed distance function values for that voxel (which may be sampled (e.g. interpolated) from signed distance function values of nearby voxels as discussed above) for any or all of the other intersecting/interpenetrating/overlapping tissue components.

FIG. 2A schematically illustrates a method 100 that may be used for the block 26 process of identifying and removing intersections/interpenetrations/overlap from tissue components according to a particular embodiment. Method 100 assumes that each tissue component has been converted to a signed distance field 25 with signed distance function values in each voxel. These signed distance fields 25 are provided as input to method 100. The input signed distance fields 25 may be referred to herein as the “original” signed distance fields and their signed distance function values may be referred to herein as “original” signed distance function values. The output of method 100 is a set of modified signed distance fields 27. Method 100 starts a block 102 which implements a loop for each input signed distance field 25 (or for each tissue component). The signed distance function 25 (or tissue component) corresponding to each iteration of the block 102 loop may be referred to herein as the “current” signed distance function (or the “current” tissue component).

Each iteration of the block 102 loop starts in block 104, where the currentl signed distance function 25 is copied to provide a copy of the current signed distance function 106. Method 100 then proceeds to optional block 108 which involves an optional evaluation of whether the current tissue component is a bone, in which case it might not be desirable to modify the signed distance field of the current tissue component. If the optional block 108 evaluation is positive (the current tissue component is bone), then method 100 proceeds to block 110 and to block 100, which is described in more detail below. If the optional block 108 evaluation is negative (the current tissue component is other than bone), then method 100 proceeds to block 114.

Block 114 involves determining other signed distance fields (from among the input signed distance fields 25) that intersect/overlap with the current signed distance field. This block 114 process may involve consideration of the bounding box of the current signed distance function and those of the other input signed distance fields. Such bounding boxes may be created based on the input geometry of input tissue representation 23 for each tissue component and/or the geometry of each corresponding signed distance field 25. For example, for each tissue component, a bounding box may be created based on the geometry of input tissue representation 23 and/or the corresponding signed distance field 25 and may specify minimum and maximum coordinates for each of three geometric coordinates (e.g. minimum and maximum values (i.e. a range) for each of (x, y, z) coordinates) for each tissue component. Overlap between a pair of signed distance fields may then be evaluated by testing if the minimum and maximum ranges overlap for all three coordinates-if so, then the two signed distance fields overlap; otherwise the two signed distance fields do not overlap. Signed distance fields (from among input signed distance fields 25) whose bounding boxes are determined (in block 114) overlap with the bounding box of the current signed distance field may be referred to as “neighboring” signed distance fields 112. Block 114 is optional. In some embodiments, all of the other tissue components input to method 20 in input tissue representation 23 (and all of their corresponding signed distance fields) may be treated as “neighboring” signed distance fields 112 and method 100 may proceed on this basis. It will be appreciated, however, that identifying neighboring signed distance fields that overlap with the current signed distance field in block 114 may lead to processing efficiencies.

Method 100 then proceeds to blocks 116 and 118 which perform a nested loop that iterates for each voxel in the current signed distance field (loop 116) and for each neighboring signed distance field 112 (loop 118). In block 120, a signed distance function value for the current neighbor signed distance field 112 is determined at the center of the current voxel of the current signed distance field. As discussed above, this block 120 process may involve interpolating the signed distance function values of a plurality of voxels of the current neighbor signed distance field 112 to determine a suitable signed distance function value at the center of the current voxel of the current signed distance field. The plurality of voxels selected for this interpolation may comprise the group of voxels of the current neighbor signed distance field 112 that intersect with the current voxel of the current signed distance field. The interpolation may be performed using any suitable technique. Currently preferred embodiments involve the use of bilinear or bicubic interpolation, although other suitable techniques, such as using weights based on the inverse of center-to-center distances between the center of each voxel of the current neighbor signed distance field 112 the center of the current voxel of the current signed distance field, sinc interpolation, radial distance function based interpolation and/or the like.

Method 100 then proceeds to block 122 which comprises modifying the signed distance function value of the current voxel of the current signed distance field to thereby generate a modified signed distance function value for the corresponding voxel in a modified signed distance field 124. The specific block 122 modification may be implemented based on suitable logic, which is described in more detail elsewhere herein. In some embodiments, the block 122 modification involves no change—i.e. the original signed distance function value is retained for the current voxel of the current signed distance field. In some embodiments, the block 122 modification is based on one of more of: the original signed distance function value for the current voxel of the current signed distance field; the neighbor signed distance function values determined in block 120 for the current voxel of the current signed distance field.

It will be appreciated that as method 100 iterated through loops 116 and 118, the signed distance function values for each voxel are determined for modified current signed distance field 124. At the conclusion of loop 116, method 100 proceeds to block 126 which involves outputting modified current signed distance field 124 as one of modified distance fields 127 that are used in the rest of method 20 (see FIG. 2). In some instances, method 100 may arrive at block 126 via block 110 (i.e. where the current tissue component is a bone). In such instances, the original signed distance field 25 for that tissue component is maintained as modified signed distance field 27—i.e. modified signed distance field 27 is the same as the original (input) signed distance field 25 for that tissue component.

In some embodiments, modifying the current voxel of the current signed distance function (in block 122) to generate modified signed distance field 124 may involve outputting: the original signed distance function value for the current voxel of the current signed distance field, if that value is less than the values sampled (in block 120) from the neighboring signed distance fields 112; or outputting a large positive value (flagging the current voxel of the current signed distance field as being outside of the current tissue component), otherwise. This block 122 modification has the effect of removing material at voxels which are further inside the neighboring tissue components than the current tissue components, and, if done for all tissue components, the overlap, interpenetrations and/or intersections may be removed in a way that agrees with user intuition on how this should happen.

In some cases, the interface between two or more different tissue components generated by the block 122 scheme described above may not align with voxels of the three-dimensional signed distance fields 25. In this case, artifacts may be introduced in the zero isosurfaces of the modified signed distance fields 27. For example, the isosurfaces of the modified signed distance fields 27 may no longer be smooth and may become jagged, stepped and/or the like.

To mitigate the introduction of artifacts (irrespective of how an interface between tissue components lines up with voxels of the three-dimensional signed distance fields), generating modified signed distance fields 27 (e.g. in block 26 of method 20 (FIG. 2) and/or in block 122 (FIG. 2A)) may involve determining a difference between: the signed distance function value at the current voxel of the current signed distance field and the block 120 signed distance function value determined for a neighboring signed distance field 112. This difference may be understood to be a “signed distance” of a third object containing all the points further inside the current tissue component (corresponding to the current signed distance field) than the neighboring tissue component (corresponding to neighbor signed distance field 112). These differences can be determined for each signed distance field determined (in block 114) to be a neighboring signed distance field 112. Then, the value of the current voxel of the current signed distance field in modified signed distance field 124 (and in modified signed distance field 27) may be set to the maximum of: the original value for the current voxel of the current signed distance field; and any determined differences. Taking this maximum has the effect of intersecting the current tissue component with this third object for each neighboring tissue component, thereby removing (from the current tissue component) all voxels that are further inside the neighboring tissue component than the current tissue component.

Since the difference between the signed distance function values of the two signed distance fields is as smooth as each of the individual signed distance fields, no artifacts (or a reduced number of artifacts) are introduced into modified signed distance fields 124, 27. In some embodiments, an additional offset value (explained in more detail below) may optionally be added to these differences between signed distance function values of the current and neighbor signed distance function fields. The offset value may be user-configurable and may be set to any suitable value.

In some embodiments, the user may wish to flag certain tissue components as “bones”, which maintain their shape while other tissue components move or deform to avoid the bones. In this case, tissue components identified as bones may be skipped (via blocks 108, 110) when it comes to modifying the signed distance function values for such tissue components (e.g. the loops 116 and 118 are skipped). Further, the block 122 modification of the current voxel of the current signed distance field may be performed in a different manner if one of the neighboring signed distance fields 112 corresponding to a tissue component is identified as a bone.

In some embodiments, where a neighboring tissue component 112 is identified as a bone, generating a modified signed distance function value for the current voxel of the current signed distance field in block 122 may comprise outputting: the original value of the current voxel of the current signed distance field, if the block 120 value sampled for the neighboring signed distance field 112 corresponding to bone is positive; or outputting a large positive value (flagging the current voxel of the current signed distance field as being outside of the current tissue component), otherwise. This modification has the effect of removing material at voxels which are inside the neighboring tissue component (bone), thereby removing interpenetrations and/or intersections with the bone. As described previously, this methodology may lead to artefacts.

To mitigate the introduction of artifacts (irrespective of how an interface between tissue components lines up with voxels of the three-dimensional signed distance fields), generating modified signed distance fields 27 (e.g. in block 26 of method 20 (FIG. 2) and/or in block 122 (FIG. 2A)) where the neighboring signed distance field 112 corresponds to a bone type tissue component may involve determining the value of the current voxel of the current signed distance field in modified signed distance field 124 (and in modified signed distance field 27) to be the maximum of: the original signed distance function value for the current voxel of the current signed distance field; and the negative of the block 120 sampled signed distance function value at the current voxel for the neighboring (bone type) signed distance field 112 plus an optional offset Δ. The negative of the neighboring (bone) signed distance field 112 may be understood to be the signed distance of a third object containing all the voxels outside the bone. Taking the maximum of the original signed distance function value for the current voxel of the current signed distance field and the negative of the block 120 sampled signed distance function value at the current voxel for the neighboring (bone type) signed distance field 112 has the effect of intersecting the current signed distance field with this third object, removing all voxels that are inside the bone.

The adjustment of signed distance function values and the corresponding generation of modified signed distance fields 27 (e.g. in block 26 of method 20 (FIG. 2) and/or the generation of modified signed distance fields 124 (e.g. in block 122 of method 100 (FIG. 2A)) is now described using a number of examples.

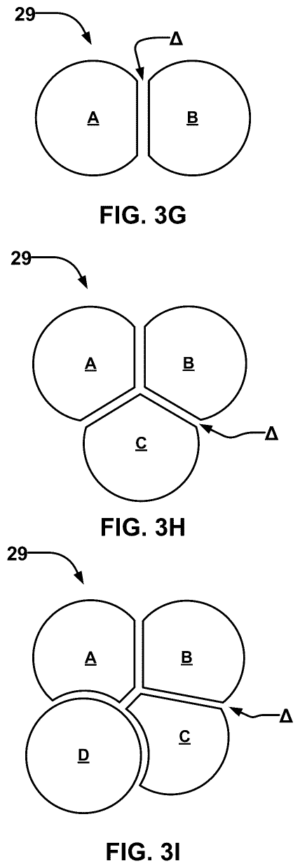

FIG. 3A schematically shows an example representation 23 having tissue components A and B (i.e. two different tissue components). Tissue components A and B overlap one another in region 31 and thus may be considered to be neighboring tissue components or neighboring signed distance functions 112 (see FIG. 2A). To remove or erode the overlapping portion (see e.g. FIG. 3B), the signed distance function values of voxels of tissue component A's original signed distance field 25A corresponding to region 31 may be replaced (in modified signed distance field 27A or modified signed distance field 124A corresponding to tissue component A) with the MAX of:
the signed distance function value of A for those voxels; and
a difference between the signed distance function value of A for those voxels and the sampled signed distance function value of B for those voxels plus an optional offset value Δ_{A,B}.
   The “sampled” signed distance function value of B for particular voxels may refer to an interpolated value of the signed distance field for tissue component B at the center of the voxel of tissue component A as discussed above (see, for example, discussion of block 120 of FIG. 2A). In the illustrated embodiment of FIGS. 3A and 3B, the offset value Δ_{A,B}=Δ_{B,A}=0. It will be appreciated that the logic presented above for the assignment of modified signed distance function values for modified signed distance field 27A or modified signed distance field 124A corresponding to tissue component A may apply throughout tissue component A, although only voxels in region 31 will have exhibit changes in their signed distance function values.

Likewise, the signed distance function values of voxels of tissue component B's original signed distance field 25B corresponding to region 31 may be replaced (in modified signed distance field 27B) with the MAX of:
the signed distance function value of B for those voxels; and
a difference between the signed distance function value of B for those voxels and the sampled signed distance function value of A for those voxels plus an optional offset value Δ_{B,A}.
The “sampled” signed distance function value of A for particular voxels may refer to an interpolated value of the signed distance field for tissue component A at the center of the voxel of tissue component B as discussed above (see, for example, discussion of block 120 of FIG. 2A). In the illustrated embodiment of FIGS. 3A and 3B, the offset value Δ_{A,B}=Δ_{B,A}=0. It will be appreciated that the logic presented above for the assignment of modified signed distance function values for modified signed distance field 27B or modified signed distance field 124B corresponding to tissue component B may apply throughout tissue component B, although only voxels in region 31 will have exhibit changes in their signed distance function values.

FIG. 3C schematically shows an example representation 23 having tissue components A, B and C. Tissue components A, B and C overlap one another in, for example, region 35 and thus may be considered to be neighboring tissue components or neighboring signed distance functions 112 (see FIG. 2A). To remove or erode the overlapping portions of region 35 (see e.g. FIG. 3D), the signed distance function values of voxels of tissue component A's original signed distance field 25A corresponding to region 35 may be replaced (in modified signed distance field 27A or modified signed distance field 124A corresponding to tissue component A) with the MAX of:
the signed distance function value of A for those voxels;
a difference between the signed distance function value of A for those voxels and the sampled signed distance function value of B for those voxels plus an optional offset value Δ_{A,B}; and
a difference between the signed distance function value of A for those voxels and the sampled signed distance function value of C for those voxels plus an optional offset value Δ_{A,C}.

The “sampled” signed distance function value of B, C for particular voxels may refer to an interpolated value of the signed distance field for tissue component B.C at the center of the voxel of tissue component A as discussed above (see, for example, the discussion of block 120 of FIG. 2A). In the illustrated embodiment of FIGS. 3C and 3D, the offset value Δ_{A,B}=Δ_{A,C}=Δ_{B,A}=Δ_{B,C}=Δ_{C,A}=Δ_{C,B}0.

The signed distance function values of voxels of tissue component B's original signed distance field 25B corresponding to region 35 may be replaced (in modified signed distance field 27B or modified signed distance field 124B corresponding to tissue component B) with the MAX of:
the signed distance function value of B for those voxels;
a difference between the signed distance function value of B for those voxels and the sampled signed distance function value of A for those voxels plus an optional offset value Δ_{B,A}; and
a difference between the signed distance function value of B for those voxels and the sampled signed distance function value of C for those voxels plus an optional offset value Δ_{B,C}.

The “sampled” signed distance function value of A, C for particular voxels may refer to an interpolated value of the signed distance field for tissue component A, C at the center of the voxel of tissue component B as discussed above (see, for example, discussion of block 120 of FIG. 2A). In the illustrated embodiment of FIGS. 3C and 3D, the offset value Δ_{A,B}=Δ_{A,C}=Δ_{B,A}=Δ_{B,C}=Δ_{C,A}=Δ_{C,B}0.

The signed distance function values of voxels of tissue component C's original signed distance field 25C corresponding to region 35 may be replaced (in modified signed distance field 27C or modified signed distance field 124C corresponding to tissue component C) with the MAX of:
the signed distance function value of C for those voxels;
a difference between the signed distance function value of C for those voxels and the sampled signed distance function value of A for those voxels plus an optional offset value Δ_{C,A}; and
a difference between the signed distance function value of C for those voxels and the sampled signed distance function value of B for those voxels plus an optional offset value Δ_{C,B}.

The “sampled” signed distance function value of A, B for particular voxels may refer to an interpolated value of the signed distance field for tissue component A, B at the center of the voxel of tissue component C as discussed above (see, for example, discussion of block 120 of FIG. 2A). In the illustrated embodiment of FIGS. 3C and 3D, the offset value Δ_{A,B}=Δ_{A,C}=Δ_{B,A}=Δ_{B,C}=Δ_{C,A}=Δ_{C,B}0.

It will be appreciated that the logic presented above can be extended to regions with more than three overlapping tissue components (e.g. neighboring tissue components 112 (see FIG. 2A)). For example, where there are N overlapping/neighboring tissue components, determining the modified signed distance field 27 or modified signed distance field 124 corresponding to a current (first) one of the N tissue components may involve, for each current voxel of the current (first) one of the N tissue components, assigning the modified signed distance function value to be the MAX of:
(i) an original signed distance function value of the current (first) one of the N tissue components for the current voxel; and
(ii) a MAX of: differences between:
   (a) the original signed distance function value of the current (first) one of the N tissue components for the current voxel; and
   (b) a sampled signed distance function value corresponding to the current voxel for any others of the N tissue components;
   plus an offset value Δ.
      The “sampled” signed distance function value corresponding to the current voxel for any others of the N tissue components for particular voxels may refer to an interpolated value of the signed distance field for the others of the N tissue components at the center of the current voxel of the current (first) tissue component as discussed above (see, for example, discussion of block 120 of FIG. 2A).

In some embodiments, method 20 does not erode all tissue components. In some cases, it is desirable to maintain some tissue components in their original representation (i.e. to not erode such tissue components). For example, it may be desirable to maintain bone tissue components as they are in their original representation, while eroding other tissue components which intersect with the bone tissue components. Doing so may generate a more anatomically correct model. For example, if a human character is being modeled, human muscle tissue wraps around bone tissue and therefore it may be desirable to maintain the bone tissue component in its original representation. Additionally, or alternatively, in some cases an artist may wish to maintain the shape of one muscle (i.e. not eroding the tissue component corresponding to such muscle) while permitting the erosion of other muscle tissue components to accommodate the shape of that muscle.

In some embodiments, method 20 (FIG. 2) may determine whether one or more tissue component types (or individual tissue components) is to be left in their original (non-eroded) state (e.g. shape). In some embodiments, tissue components within representation 23 each comprise a flag or other identifier which identifies whether the corresponding tissue component is to be left in its original (non-eroded) state. In some embodiments, representation 23 comprises a global data field which identifies which tissue components (if any) within representation 23 are to be left in their original state. In some embodiments representation 23 comprises information which identifies each tissue component within representation 23 by type.

In some embodiments, a user selects one or more tissue components which are to be left in their original state. In some embodiments, method 20 automatically selects which tissue components (if any) are to be left in their original state. For example, method 20 may scan representation 23 for identifying features of particular tissue components (e.g. shapes which are particular to specific bones, etc.).

In some embodiments, all tissue components identified as the same type within representation 23 are treated in the same manner.

FIG. 3E schematically shows an example representation 23 having tissue components A, B, C and D. Tissue components A, B and C may be eroded (e.g. may correspond to muscles). Tissue component D is to remain in its original state (e.g. may correspond to bone) (see e.g. FIG. 3F). Tissue components A and D overlap in region 37. Tissue components C and D overlap in region 38. Tissue components A, C and D overlap in region 39. Since tissue component D is to remain in its original state no new values for the signed distance field corresponding to tissue component D are generated. However, to remove or erode the overlapping portions between tissue components A, C and D:
signed distance function values of voxels of tissue component A's original signed distance field 25A may be replaced (in modified signed distance field 27A or modified signed distance field 124A) with the MAX of:
   the signed distance function value of A for those voxels;
   the negative of a sampled signed distance function value of D for those voxels plus an optional offset value Δ_{A,D};
   a difference between the original signed distance function value of A for those voxels and a sampled signed distance function value of C for those voxels plus an optional offset value Δ_{A,C}; and
   a difference between the original signed distance function value of A for those voxels and a sampled signed distance function value of B for those voxels plus an optional offset value Δ_{A,B}; and
signed distance function values of voxels of tissue component B's original signed distance field 25B may be replaced (in modified signed distance field 27B or modified signed distance field 124B) with the MAX of:
   the original signed distance function value of B for those voxels;
   the negative of a sampled signed distance function value of D for those voxels plus an optional offset value Δ_{B,D}; and
   a difference between the original signed distance function value of B for those voxels and a sampled signed distance function value of A for those voxels plus an optional offset value Δ_{B,A}; and
   a difference between the original signed distance function value of B for those voxels and a sampled signed distance function value of V for those voxels plus an optional offset value Δ_{B,C}; and
signed distance function values of voxels of tissue component C's original signed distance field 25C may be replaced (in modified signed distance field 27C or modified signed distance field 124A) with the MAX of:
   the original signed distance function value of C for those voxels;
   the negative of a sampled signed distance function value of D for those voxels plus an optional offset value Δ_{C,D}; and
   a difference between the original signed distance function value of C for those voxels and a sampled signed distance function value of A for those voxels plus an optional offset value Δ_{C,A}; and
   a difference between the original signed distance function value of C for those voxels and a sampled signed distance function value of B for those voxels plus an optional offset value Δ_{C,B}.
      In the illustrated embodiment of FIGS. 3E and 3F, the all offset values Δ=0. A “sampled” signed distance function value may refer to an interpolated value of the corresponding signed distance field at the center of a voxel of another tissue component as discussed above (see, for example, discussion of block 120 of FIG. 2A).

It will be appreciated that the logic presented above can be extended to regions with N overlapping/neighboring tissue components where one or more of them is identified as a bone or where it is otherwise undesirable to modify one or more particular tissue components. In such a case, determining the modified signed distance field 27 or modified signed distance field 124 corresponding to a current (first) one of the N tissue components may involve, for each current voxel of the current (first) one of the N tissue components, assigning the modified signed distance function value to be the MAX of:
(i) an original signed distance function value of the current (first) one of the N tissue components for the current voxel;
(ii) the negative of a sampled signed distance function value corresponding to the current voxel for any others of the N tissue components that are identified as a bone tissue component type or are otherwise indicated to be non-modifiable plus an optional offset value Δ_{1,2}; and
(ii) a MAX of: differences between:
   (a) the original signed distance function value of the current (first) one of the N tissue components for the current voxel; and
   (b) a sampled signed distance function value corresponding to the current voxel for any others of the N tissue components that are identified as any other (non-bone) tissue component type or are otherwise indicated to be modifiable;
   plus an offset value Δ.
      The “sampled” signed distance function value corresponding to the current voxel for any others of the N tissue components may refer to an interpolated value of the signed distance field for the others of the N tissue components at the center of the current voxel of the current (first) tissue component as discussed above (see, for example, discussion of block 120 of FIG. 2A).

In some embodiments, where there are multiple bone tissue components, it may be desirable to perform method 20 two times. In a first iteration of method 20, the tissue components may include only the bone type tissue components and some or all of the bone tissue components may be treated as being modifiable (e.g. just like muscle tissue components discussed elsewhere herein) to remove penetrations from among the bone tissue components. In a second iteration of method 20, the soft tissue components (tissue components other than bone) can be re-introduced to the method, so that penetrations are removed as between these soft tissue components and the bone tissue components and as between the soft tissue components themselves.

In some embodiments, it is desirable to have a small separation between adjacent tissue components in model 10′. It may be desirable for such a separation to be large enough that there are no detectable collision hits between adjacent tissue components 12′ during simulation of model 10′, but small enough that a simulation model is not visually affected (e.g. the separation does not visually distort a simulation model). For example, adjacent tissue components 12′ in model 10′ may be separated from one another by a separation of about 5% or less than the size of the original mesh. Separations between adjacent tissue components may be introduced using the offset parameter A (also referred to as Δ_{i,j}) discussed above (i.e. by assigning non-zero values to the offset parameter). The offset parameter may be user-configurable. In currently preferred embodiments, offset Δ is about 5% or less than a maximal cross-sectional dimension of the original mesh. The offset parameter may be the same for an entire model 10′ or different offsets may be applied between different tissue components within model 10′.

FIGS. 3G, 3H and 3I schematically show non-zero offsets A introduced to the representations of FIGS. 3B, 3D and 3F respectively.

The logic presented herein assumes that signed distance fields are created according to the sign convention that negative signed distance function values are assigned to regions inside of a closed surface (e.g. inside of the surface mesh corresponding to a tissue component) and that positive signed distance function values are assigned to regions outside of a closed surface (e.g. outside of the surface mesh corresponding to a tissue component). As is known in the field of signed distance functions, this is merely a convention and the opposite convention could be used—that is, positive signed distance function values could be assigned to regions inside of a closed surface (e.g. inside of the surface mesh corresponding to a tissue component) and negative signed distance function values could be assigned to regions outside of a closed surface (e.g. outside of the surface mesh corresponding to a tissue component). Those skilled in the art will appreciate, on the basis of this disclosure, that analogous logic could be applied to modify the signed distance function values for particular tissue components where the signed distance function values adopt this opposite sign convention.

Returning to FIG. 2, once modified signed distance fields 27 have been generated in block 26, modified signed distance fields 27 are converted back into polygonal mesh representations. In block 28, a new polygonal mesh representation 29 of the tissue components to be modeled is generated based on modified signed distance fields 27. The new polygonal mesh 29 is typically of the same type as the polygonal mesh used to represent the tissue in input representation 23.

Block 28 may comprise, for example, generating a new explicit mesh for each tissue component whose signed distance function was modified by method 20 (e.g. for each modified signed distance field 27). A new explicit mesh may, for example, be generated for each tissue component in block 28 based on the corresponding modified signed distance field 27 using an isosurface reconstruction method, such as marching cubes on the modified grids. The vertices of the explicit mesh may be located on a zero isosurface of the corresponding modified signed distance field. It will be appreciated that a zero isosurface of the corresponding modified distance field represents a surface of the corresponding modified tissue component.

Creating the explicit mesh for each tissue component in block 28 may comprise projecting surface vertices of the original mesh (e.g. input representation 23) corresponding to the tissue component onto the zero isosurface corresponding to the tissue component to generate new vertices in the explicit mesh. Original surface vertices may, for example, be projected onto the isosurface to generate corresponding vertices of the explicit mesh with a closest point query method. The explicit mesh may then be relaxed and/or otherwise optimized to produce a mesh that corresponds as much as possible to the original mesh used to represent the tissue component in input representation 23.

In some embodiments, relaxing and/or otherwise optimizing the explicit mesh in block 28 comprises using one or more energy functions which attribute cost to variations in the shapes of polygons (e.g. triangles etc.), which make up the explicit mesh as compared to shapes of polygons in the input mesh of representation 23. In some embodiments, the energy functions used in block 28 may comprise other additional or alternative cost terms, which may be based on other criteria which involve comparing the explicit mesh generated based on modified signed distance field 27 to the original representation 23 mesh. Such cost terms may comprise terms based on deformation energy. Such cost terms may comprise terms based on so-called as-rigid-as-possible deformation. Such costs terms may comprise terms based on Dirichlet energy. In some embodiments, the explicit mesh is relaxed and/or otherwise optimized by moving vertices of the polygons which make up the explicit mesh while constraining the vertex locations to the zero isosurface generated based on modified signed distance field 27. Movement of vertices off of the zero isosurface may reintroduce interpenetrations between tissue components.

In some embodiments, a solver such as an “Alternating Direction Method of Modifiers” (ADMM) solver is used to relax and/or optimize the mesh in block 28. In some embodiments, block 28 may involve the use of other additional or alternative optimization methods which minimize energy (or energies), so as to encourage the polygons of the mesh to adopt sensible shapes, while constraining the vertices to a surface (e.g. the zero isosurface).

In some embodiments, a constrained coordinate descent is used in block 28 to relax and/or optimize the mesh. In some such embodiments, a vertex is picked. The vertex is then moved to an average position of its neighbors. The vertex may then be projected onto the isosurface. A next vertex may then be selected and the steps repeated until the mesh is smooth within a desired range.

In some embodiments, deformation of the original mesh of representation 23 is penalized in block 28 (i.e. the energy function used to optimize or relax the explicit mesh in block 28 attributes cost to deformation of the explicit mesh relative to the original mesh in input representation 23). In some embodiments, the explicit mesh is only relaxed and/or optimized over the set of polygons (e.g. triangles) and/or vertices that have been moved from their original position during method 20. Movement of polygons and/or vertices from their original position may be tracked by comparing which voxels have new values for their corresponding signed distance fields within modified signed distance fields 27.

In some embodiments, the number of iterations of the solver (optimization) used to perform the relaxation in block 28 is a user configurable parameter.

The output of block 28 is a new tissue representation 29. Tissue model 10′ shown in FIG. 1B is an example of an output tissue representation 29 from method 20. In tissue representation 29, tissue components do not overlap, interpenetrate and/or intersect one another (i.e. there is no tissue penetration as between tissue components). As compared to input tissue representation 23, tissue representation 29 may advantageously produce higher fidelity simulations and may producer faster simulations (due to, for example, a reduced amount of collisions that may occur at any given time). Output tissue representation 29 may be compatible with commercially available simulation software products (e.g. Houdini™ developed by Side Effects Software Inc., a Ziva™ simulator developed by Ziva Dynamics, etc.) and/or the like.

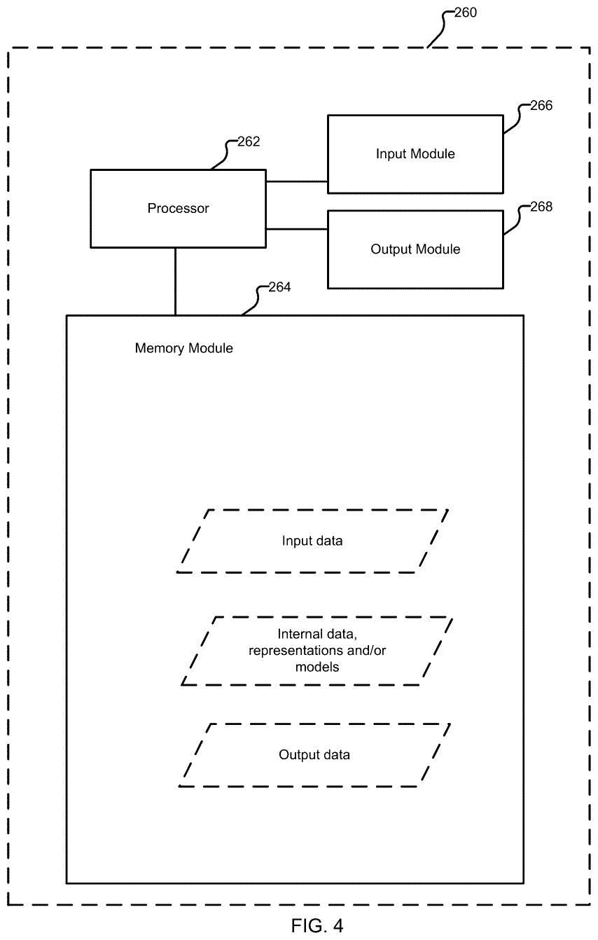

Some aspects of the invention provide a system 260 (an example embodiment of which is shown in FIG. 4) for performing one or more of the methods described herein (e.g. the methods FIGS. 2, 2A and/or portions thereof). System 260 may comprise a processor 262, a memory module 264, an input module 266, and an output module 268. Memory module 264 may store any of the models, data and/or representations described herein—e.g. those shown in parallelogram-shaped boxes in other drawings. Processor 262 may receive (via input module 266) any inputs to any of the methods described herein and may store these inputs in memory module 264. Processor 262 may perform any of the methods described herein (and/or portions thereof). Processor 262 may output (via output module 268) any of the data and/or outputs of any of the methods described herein.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for mitigating tissue penetration in a musculoskeletal model used for computer animation, the method comprising:
obtaining a computer-based input representation of the musculoskeletal system, the input representation comprising an input surface mesh for each of a plurality of tissue components;
for each of the tissue components, generating a signed distance field, the signed distance field comprising: a plurality of voxels arranged in a three-dimensional grid; and, for each voxel, a signed distance function value indicative of a distance of the voxel from a surface of the tissue component and whether the voxel is inside of the tissue component or outside of the tissue component;
for each of one or more particular tissue components from among the plurality of tissue components, modifying a signed distance field of the particular tissue component to thereby generate a corresponding modified signed distance field for the particular tissue component;
generating a computer-based output representation of the musculoskeletal system, wherein generating the output representation comprises, for each of the one or more particular tissue components, generating a corresponding output surface mesh for the particular tissue component based on the corresponding modified signed distance field for the particular tissue component;
wherein, for each of the one or more particular tissue components, the corresponding output surface mesh for the particular tissue component is free from penetration by other ones of the plurality of tissue components.

2. A method according to claim 1 wherein generating the signed distance field comprises, for each tissue component and for each voxel: adopting one of: a first sign convention wherein a negative signed distance function value indicates that the voxel is located inside of the tissue component and a positive signed distance function value indicates that the voxel is outside of the tissue component; and a second sign convention wherein a positive signed distance function value indicates that the voxel is located inside of the tissue component and a negative signed distance function value indicates that the voxel is outside of the tissue component.

3. A method according to claim 2 wherein:
generating the signed distance field comprises adopting the first sign convention and modifying the signed distance field of the particular tissue component comprises:
identifying one or more neighboring tissue components and one or more corresponding neighboring signed distance fields from among the other ones of the plurality of tissue components;
for each voxel of a subset of voxels of the signed distance field of the particular tissue component:
for each of the neighboring tissue components:
if an original signed distance function value for the voxel of the subset is greater than a neighbor value sampled from original signed distance values of one or more corresponding voxels of the neighboring tissue component, then assigning, to the voxel of the subset, a modified signed distance function value that is positive;
otherwise assigning, to the voxel of the subset, a modified signed distance function value that is equal to the original signed distance function value for the voxel of the subset;
or
generating the signed distance field comprises adopting the second sign convention and modifying the signed distance field of the particular tissue component comprises, for each voxel of a subset of voxels of the signed distance field of the particular tissue component, modifying the signed distance function value of the voxel of the subset in a manner according to analogous logic to that recited above for the first sign convention.

4. A method according to claim 2 wherein:
generating the signed distance field comprises adopting the first sign convention and modifying the signed distance field of the particular tissue component comprises:
identifying one or more neighboring tissue components and one or more corresponding neighboring signed distance fields from among the other ones of the plurality of tissue components;
for each voxel of a subset of voxels of the signed distance field of the particular tissue component:
for each of the neighboring tissue components:
if the neighboring tissue component has a tissue component type of bone or the tissue component is otherwise indicated to be non-modifiable and a neighbor value sampled from the original signed distance values of one or more corresponding voxels of the neighboring tissue component is negative, then assigning, to the voxel of the subset, a modified signed distance function value that is positive;
if the neighboring tissue component has any other tissue component type or is otherwise indicated to be modifiable and an original signed distance function value for the voxel of the subset is greater than a neighbor value sampled from original signed distance values of one or more corresponding voxels of the neighboring tissue component, then assigning, to the voxel of the subset, a modified signed distance function value that is positive;
otherwise assigning, to the voxel of the subset, a modified signed distance function value that is equal to the original signed distance function value for the voxel of the subset;
or
generating the signed distance field comprises adopting the second sign convention and modifying the signed distance field of the particular tissue component comprises, for each voxel of a subset of voxels of the signed distance field of the particular tissue component, modifying the signed distance function value of the voxel of the subset in a manner according to analogous logic to that recited above for the first sign convention.

5. A method according to claim 3 wherein identifying one or more neighboring tissue components and one or more corresponding neighboring signed distance fields from among the other ones of the plurality of tissue components comprises identifying all of the other ones of the plurality of tissue components to be neighboring tissue components.

6. A method according to claim 3 wherein identifying one or more neighboring tissue components and one or more corresponding neighboring signed distance fields from among the other ones of the plurality of tissue components comprises identifying, as the one or more neighboring tissue components, tissue components from among the plurality of tissue components that overlap in space with the particular tissue component.

7. A method according to claim 6 wherein identifying tissue components from among the plurality of tissue components that overlap in space with the particular tissue component comprises:
generating a bounding box for each of the plurality of tissue components wherein the bounding box comprises, for each of the plurality of tissue components, a spatial coordinate range of the tissue component in three dimensions; and
comparing the bounding box of the particular tissue component to the bounding box of each of the other ones of the plurality of tissue components to thereby determine neighboring tissue components as those whose spatial coordinate ranges overlap with that of the particular tissue component on the three dimensions.

8. A method according to claim 3 comprising, for each voxel of the subset of voxels of the signed distance field of the particular tissue component and for each of the neighboring tissue components:
determining the neighbor value sampled from original signed distance values of one or more corresponding voxels of the neighboring tissue component based on determining the one or more corresponding voxels of the neighboring tissue component to overlap in space with the voxel of the subset.

9. A method according to claim 8 wherein, for each voxel of the subset of voxels of the signed distance field of the particular tissue component and for each of the neighboring tissue components, determining the neighbor value sampled from original signed distance values of one or more corresponding voxels of the neighboring tissue component comprises interpolating the original signed distance function values of the one or more corresponding voxels of the neighboring tissue component.

10. A method according to claim 9 wherein interpolating the original signed distance function values of the one or more corresponding voxels of the neighboring tissue component comprises at least one of: bilinear interpolation and bicubic interpolation.

11. A method according to claim 2 wherein:
generating the signed distance field comprises adopting the first sign convention and modifying the signed distance field of the particular tissue component comprises:
identifying one or more neighboring tissue components and one or more corresponding neighboring signed distance fields from among the other ones of the plurality of tissue components;
for each voxel of a subset of voxels of the signed distance field of the particular tissue component, assigning, to the voxel of the subset, a modified signed distance function value that is a maximum of:
an original signed distance function value for the voxel of the subset; and
for each of the neighboring tissue components:
a difference between an original signed distance function value for the voxel of the subset and a neighbor value sampled from original signed distance values of one or more corresponding voxels of the neighboring tissue component plus an offset Δ;
or
generating the signed distance field comprises adopting the second sign convention and modifying the signed distance field of the particular tissue component comprises, for each voxel of a subset of voxels of the signed distance field of the particular tissue component, modifying the signed distance function value of the voxel of the subset in a manner according to analogous logic to that recited above for the first sign convention.

12. A method according to claim 2 wherein:
generating the signed distance field comprises adopting the first sign convention and modifying the signed distance field of the particular tissue component comprises:
identifying one or more neighboring tissue components and one or more corresponding neighboring signed distance fields from among the other ones of the plurality of tissue components;
for each voxel of a subset of voxels of the signed distance field of the particular tissue component, assigning, to the voxel of the subset, a modified signed distance function value that is a maximum of:
an original signed distance function value for the voxel of the subset;
for each of the neighboring tissue components having a tissue component type of bone or where the neighboring tissue component is otherwise indicated to be non-modifiable, a negative of a neighbor value sampled from original signed distance values of one or more corresponding voxels of the neighboring tissue component plus an offset Δ; and
for each of the neighboring tissue components having any other tissue component type or where the neighboring tissue component is otherwise indicated to be modifiable, a difference between an original signed distance function value for the voxel of the subset and a neighbor value sampled from original signed distance values of one or more corresponding voxels of the neighboring tissue component plus an offset Δ;
or
generating the signed distance field comprises adopting the second sign convention and modifying the signed distance field of the particular tissue component comprises, for each voxel of a subset of voxels of the signed distance field of the particular tissue component, modifying the signed distance function value of the voxel of the subset in a manner according to analogous logic to that recited above for the first sign convention.

13. A method according to claim 11 wherein identifying one or more neighboring tissue components and one or more corresponding neighboring signed distance fields from among the other ones of the plurality of tissue components comprises identifying all of the other ones of the plurality of tissue components to be neighboring tissue components.

14. A method according to claim 11 wherein identifying one or more neighboring tissue components and one or more corresponding neighboring signed distance fields from among the other ones of the plurality of tissue components comprises identifying, as the one or more neighboring tissue components, tissue components from among the plurality of tissue components that overlap in space with the particular tissue component.

15. A method according to claim 14 wherein identifying tissue components from among the plurality of tissue components that overlap in space with the particular tissue component comprises:
generating a bounding box for each of the plurality of tissue components wherein the bounding box comprises, for each of the plurality of tissue components, a spatial coordinate range of the tissue component in three dimensions; and
comparing the bounding box of the particular tissue component to the bounding box of each of the other ones of the plurality of tissue components to thereby determine neighboring tissue components as those whose spatial coordinate ranges overlap with that of the particular tissue component on the three dimensions.

16. A method according to claim 11 comprising, for each voxel of the subset of voxels of the signed distance field of the particular tissue component and for each of the neighboring tissue components:
determining the neighbor value sampled from original signed distance values of one or more corresponding voxels of the neighboring tissue component based on determining the one or more corresponding voxels of the neighboring tissue component to overlap in space with the voxel of the subset.

17. A method according to claim 16 wherein, for each voxel of the subset of voxels of the signed distance field of the particular tissue component and for each of the neighboring tissue components, determining the neighbor value sampled from original signed distance values of one or more corresponding voxels of the neighboring tissue component comprises interpolating the original signed distance function values of the one or more corresponding voxels of the neighboring tissue component.

18. A method according to claim 17 wherein interpolating the original signed distance function values of the one or more corresponding voxels of the neighboring tissue component comprises at least one of: bilinear interpolation and bicubic interpolation.

19. A method according to claim 11 wherein the offset value Δ=0.

20. A method according to claim 11 wherein the offset value Δ>0.

21. A method according to claim 11 wherein the offset value Δ≥0 and the offset value is different as between at least some of the neighboring tissue components.

22. A method according to claim 1 wherein generating the corresponding output surface mesh for the particular tissue component based on the corresponding modified signed distance field for the particular tissue component comprises:
determining a zero isosurface of the corresponding modified signed distance field for the particular tissue component;
for each vertex of the input surface mesh for the particular tissue component, determining a corresponding point on the zero isosurface to be a corresponding output vertex of the corresponding output surface mesh; and
determining a final configuration of the corresponding output surface mesh by allowing the output vertices of the corresponding output surface mesh to move while constraining the output vertices of the corresponding output surface mesh to the zero isosurface.

23. A method according to claim 22 wherein, for each vertex of the input surface mesh for the particular tissue component, determining the corresponding point on the zero isosurface to be the corresponding output vertex of the corresponding output surface mesh comprises determining a closest point on the zero isosurface to the vertex of the input surface mesh for the particular tissue component.

24. A method according to claim 22 wherein allowing the output vertices of the corresponding output surface mesh to move while constraining the output vertices of the corresponding output surface mesh to the zero isosurface comprises performing an iterative constrained optimization operation that minimizes an energy function which assigns cost to deformation of the corresponding output surface mesh for the particular tissue component relative to the input surface mesh for the particular tissue component while constraining the output vertices of the corresponding output surface mesh to the zero isosurface.

25. A method according to claim 24 wherein a number of iterations of the iterative constrained optimization operation is a user-configurable parameter of the method.

26. A method according to claim 1 wherein, for each of the tissue components, a size of the voxels in the signed distance field is a user-configurable parameter.

27. A system for mitigating tissue penetration in a musculoskeletal model used for computer animation, the system comprising a processor configured to perform the method of claim 1.

28. A computer program product comprising a non-transient computer-readable storage medium having data stored thereon representing software executable by a process, the software comprising instructions to perform the method of claim 1.
